(19) United States
(12) Patent Application Publication
(10) Pub. No.: US 2004/0035662 A1
(43) Pub. Date: Feb. 26, 2004

(54) Suitcase handle device

(76) Inventor: Wen-Chen Chang, Taichung (TW)

Correspondence Address: Wen-Chen Chang, 58, MA YUAN WEST ST., TAICHUNG, TW

(21) Appl. No.: 10/647,869

(22) Filed: Aug. 22, 2003

Related U.S. Application Data
(63) Continuation-in-part of application No. 10/124,700, filed on Apr. 10, 2002.

(51) Int. Cl. A45C 13/30; A45C 13/00; A47B 95/02; A47J 45/00

(52) U.S. Cl. 190/115; 16/113.1; 280/47.315; 280/37

(57) ABSTRACT

A suitcase handle device has a hollow seat disposed on the suitcase, a telescopic tube inserted through the hollow seat, a hollow mount disposed on the telescopic tube. A turret is disposed on the hollow mount. The turret has a center aperture, a plurality of periphery grooves, and an annular groove. A grip has an inner wall, a bottom round hole, a threaded hole, an end groove, and an end opening communicating with the end groove. An oblong block has an end pillar. The shaft is inserted through the center aperture. A bolt is inserted through the threaded hole and the annular groove. The turret is inserted through the bottom round hole. A spring and the oblong block are inserted in the end groove of the grip.

### CROSS-REFERENCES TO RELATED APPLICATIONS

The present invention is a continuation-in-part application of the co-pending U.S. Ser. No. 10/124,700, filed on Apr. 10, 2002.

### BACKGROUND OF THE INVENTION

The present invention relates to a suitcase handle device. More particularly, the present invention relates to a handle device for a suitcase to be rotated easily.

A conventional grip for a suitcase cannot be rotated to a predetermined direction. A user should lift the suitcase and place the suitcase to the predetermined direction. Thus U.S. Pat. No. 5,075,925 has disclosed a retractable handle assembly. U.S. Pat. No. 5,371,923 has disclosed a handle for a baggage cart. U.S. Pat. No. 5,547,053 has disclosed a spring loaded luggage handle. U.S. Pat. No. 6,081,967 has disclosed an operating device for a telescopic handle. U.S. Pat. No. 6,317,924 has disclosed a luggage handle. U.S. Pat. No. 6,564,426 has disclosed a retractable handle assembly.

### SUMMARY OF THE INVENTION

An object of the present invention is to provide a suitcase handle device to be rotated easily.

Another object of the present invention is to provide a suitcase handle device to be rotated three hundred and sixty degrees.

Accordingly, a suitcase handle device is disposed on a suitcase, and the suitcase handle device comprises a hollow seat disposed on the suitcase, a telescopic tube inserted through the hollow seat, a hollow mount disposed on the telescopic tube, a shaft, a grip, an oblong block, a spring, and a bolt. A turret is disposed on the hollow mount. The turret has a center aperture, a plurality of periphery grooves, and an annular groove. The grip has an inner wall, a bottom round hole, a threaded hole, an end groove, and an end opening communicating with the end groove. The oblong block has an end pillar and an inner protrusion. The shaft is inserted through the center aperture of the hollow mount. The bolt is inserted through the threaded hole of the grip and the annular groove of the turret. The turret is inserted through the bottom round hole of the grip. The spring and the oblong block are inserted in the end groove of the grip. The spring encloses the end pillar. The spring is disposed between the oblong block and the inner wall of the grip. The inner protrusion is inserted in one of the periphery grooves of the turret.

### BRIEF DESCRIPTION OF THE DRAWINGS

FIG. 1 is a perspective exploded view of a suitcase handle device of a preferred embodiment in accordance with the present invention;

FIG. 1A is a perspective view of an oblong block of a preferred embodiment in accordance with the present invention;

FIG. 1B is a perspective view of a hollow mount of a preferred embodiment in accordance with the present invention;

FIG. 2 is a sectional schematic view illustrating a suitcase handle device of a preferred embodiment not pulled upward;

FIG. 3 is a sectional schematic view illustrating a suitcase handle device of a preferred embodiment being pulled upward;

FIG. 4 is an elevational schematic view illustrating a suitcase handle device of a preferred embodiment being rotated;

FIG. 5 is a sectional schematic view illustrating a suitcase handle device of a preferred embodiment being fixed;

FIG. 6 is a sectional schematic view illustrating a suitcase handle device of a preferred embodiment being rotated; and

FIG. 7 is a schematic view illustrating an application of a suitcase handle device of a preferred mbodiment in accordance with the present invention.

### DETAILED DESCRIPTION OF THE INVENTION

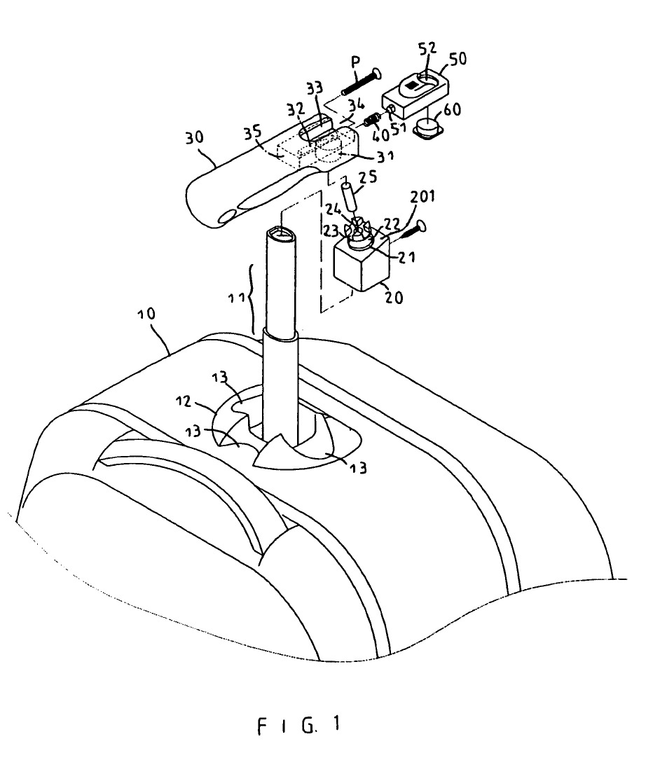

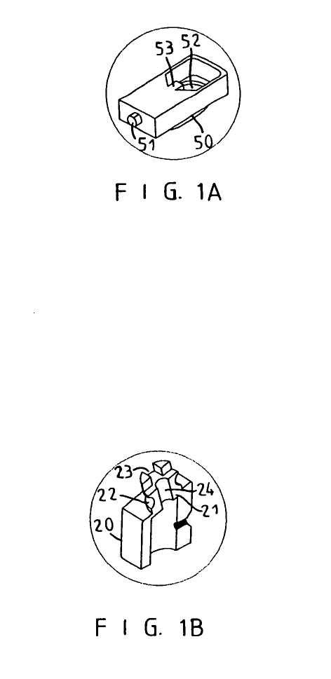

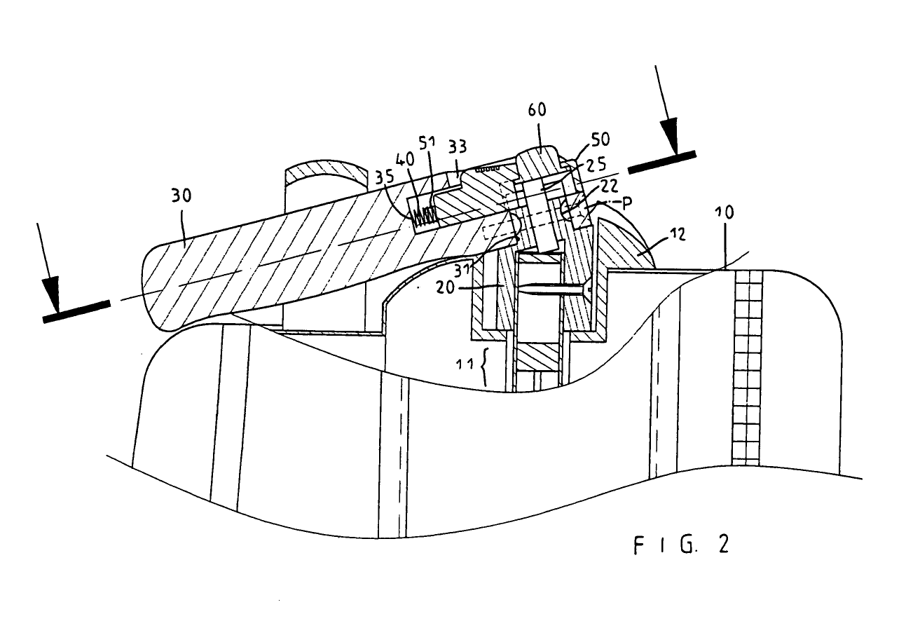

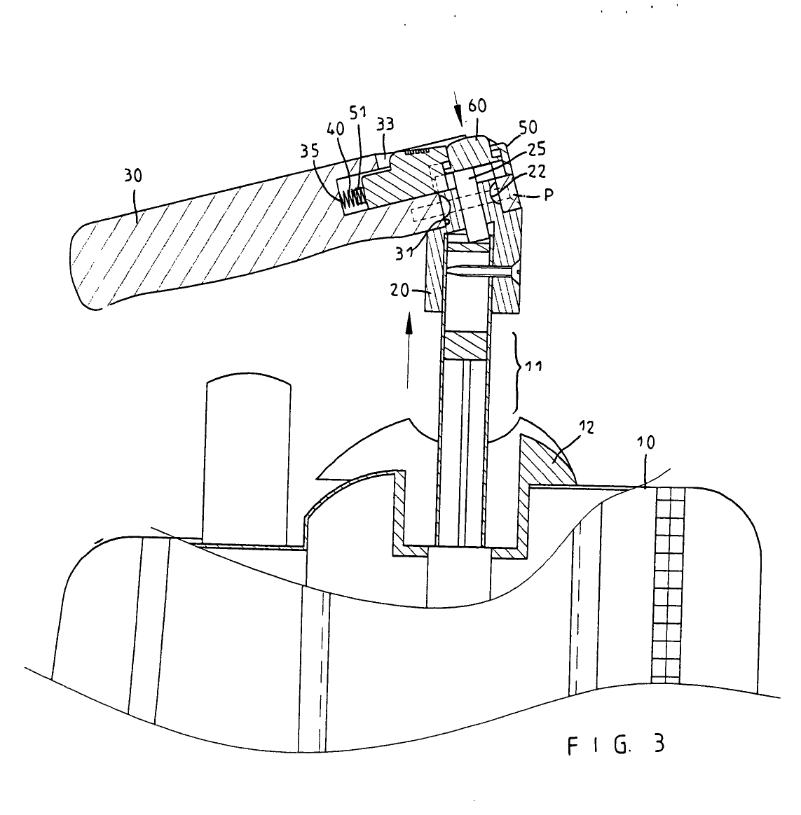

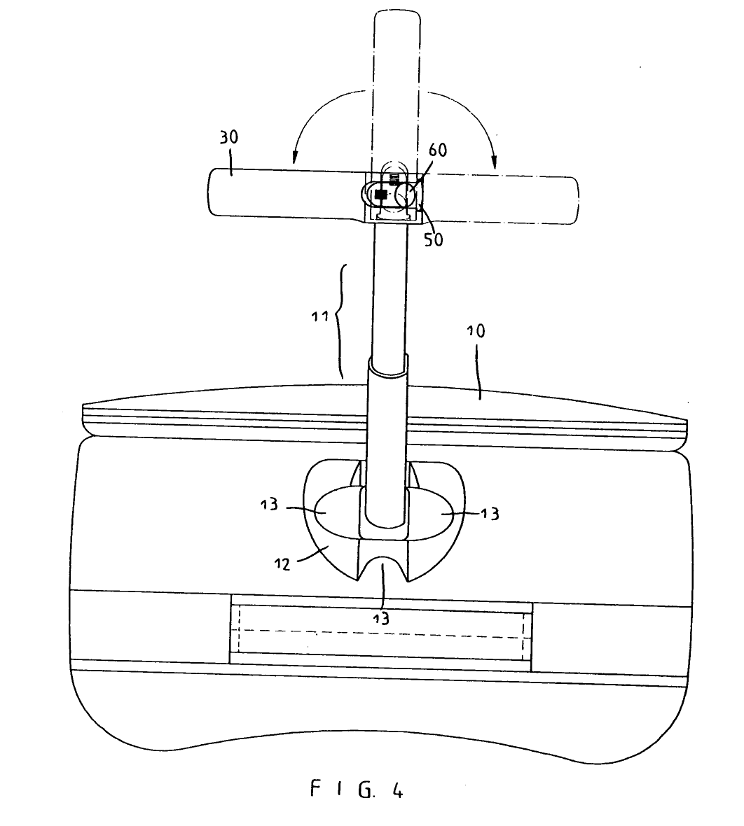

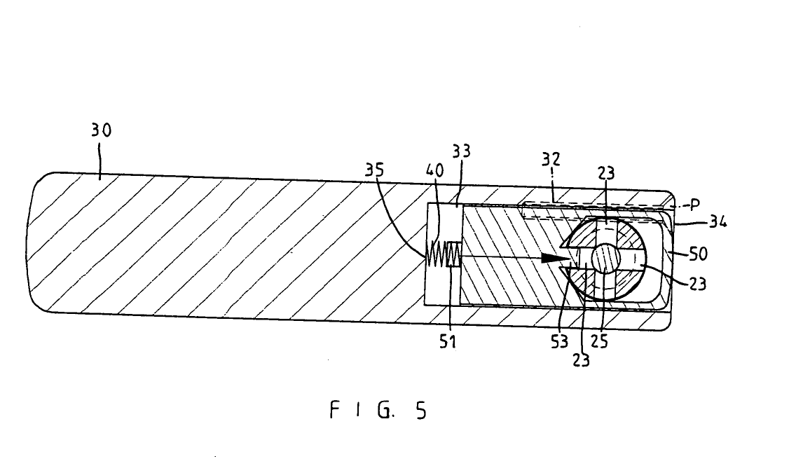

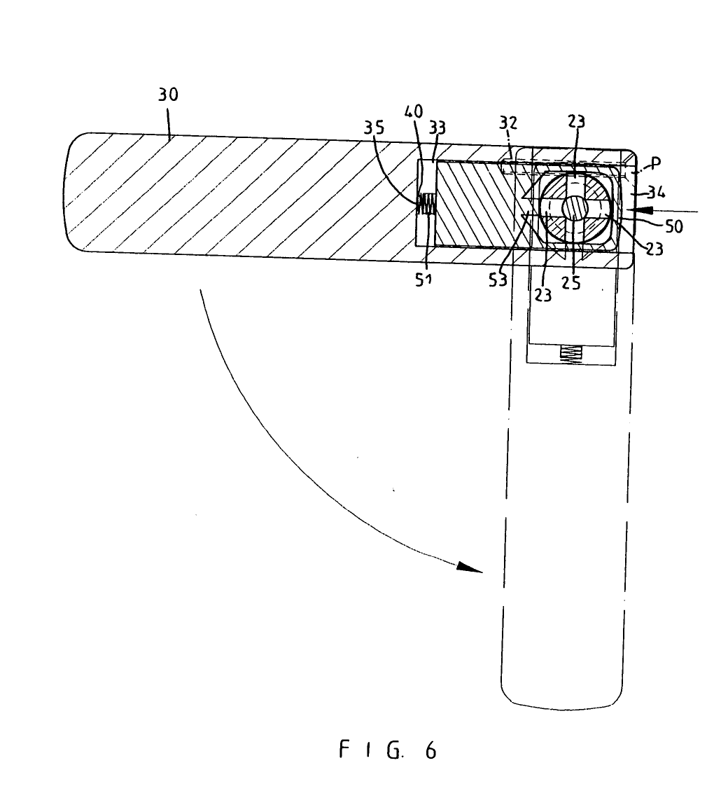

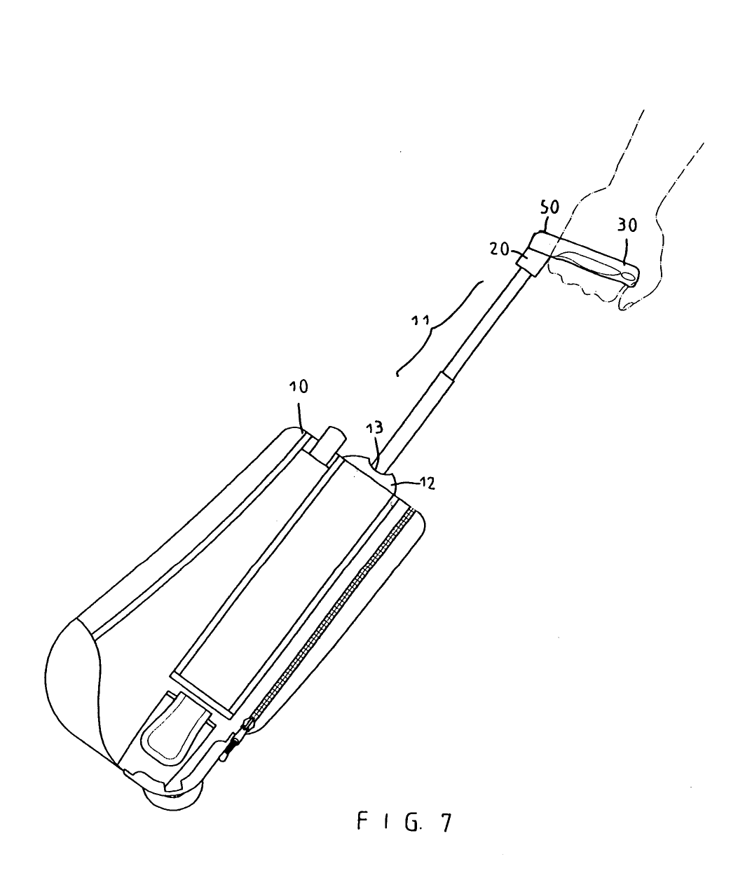

Referring to FIGS. 1 to 7, a suitcase handle device is disposed on a suitcase 10. The suitcase handle device is generally in an L shape.

The suitcase handle device comprises a hollow seat 12 disposed on the suitcase 10, a telescopic tube 11 inserted through the hollow seat 12, a hollow mount 20 disposed on the telescopic tube 11, a shaft 25, a grip 30, an oblong block 50, a pressing button 60, a spring 40, and a bolt P.

The hollow seat 12 has a plurality of periphery recesses 13.

A turret 21 is disposed on the hollow mount 20.

The turret 21 has a center aperture 24, a plurality of periphery grooves 23, and an annular groove 22.

The grip 30 has an inner wall 35, a bottom round hole 31, a threaded hole 32, an end groove 33, and an end opening 34 communicating with the end groove 33.

The oblong block 50 has an end pillar 51, a circular hole 52, and an inner protrusion 53.

The shaft 25 is inserted through the center aperture 24 of the hollow mount 20.

The bolt P is inserted through the threaded hole 32 of the grip 30 and the annular groove 22 of the turret 21.

The turret 21 is inserted through the bottom round hole 31 of the grip 30.

The spring 40 and the oblong block 50 are inserted in the end groove 33 of the grip 30.

The spring 40 encloses the end pillar 51.

The end pillar 51 faces the inner wall 35 of the grip 30.

The spring 40 is disposed between the oblong block 50 and the inner wall 35 of the grip 30.

The pressing button 60 is inserted in the circular hole 52 of the oblong block 50.

The pressing button 60 is adjacent to the shaft 25.

The inner protrusion 53 is inserted in one of the periphery grooves 23 of the turret 21.

The hollow mount 20 has an inclined upper surface 201.

When the pressing button 60 is pressed downward, the shaft 25 will move downward.

Then the inner protrusion 53 disengages from one of the periphery grooves 23 of the turret 21.

The grip 30 will be rotated three hundred and sixty degrees by a user.

When the pressing button 60 is released, the inner protrusion 53 will be inserted in one of the periphery grooves 23 of the turret 21.

One of the periphery recesses 13 of the hollow seat 12 receives the grip 30 while the telescopic tube 11 is contracted to the utmost.

The present invention is not limited to the above embodiment but various modification thereof may be made. Furthermore, various changes in form and detail may be made without departing from the scope of the present invention.

I claim:

1. A suitcase handle device dispos d on a suitcase, and the suitcase handle device comprising:
a hollow seat disposed on the suitcase, a telescopic tube inserted through the hollow seat, a hollow mount disposed on the telescopic tube, a shaft, a grip, an oblong block, a spring, and a bolt,
a turret disposed on the hollow mount,
the turret having a center aperture, a plurality of periphery grooves, and an annular groove,
the grip having an inner wall, a bottom round hole, a threaded hole, an end groove, and an end opening communicating with the end groove,
the oblong block having an end pillar and an inner protrusion,
the shaft inserted through the center aperture of the hollow mount,
the bolt inserted through the threaded hole of the grip and the annular groove of the turret,
the turret inserted through the bottom round hole of the grip,
the spring and the oblong block inserted in the end groove of the grip,
the spring enclosing the end pillar,
the spring disposed between the oblong block and the inner wall of the grip, and
the inner protrusion inserted in one of the periphery grooves of the turret.

2. The suitcase handle device as claimed in claim 1, wherein the oblong block further has a circular hole and a pressing button is inserted in the circular hole of the oblong block.

3. The suitcase handle device as claimed in claim 1, wherein the hollow mount has an inclined upper surface.

4. The suitcase handle device as claimed in claim 1, wherein the hollow seat has a plurality of periphery recesses.
